(19) United States
(12) Patent Application Publication
(10) Pub. No.: US 2026/0185269 A1
(43) Pub. Date: Jul. 2, 2026

(54) SPIN-DIE MANIFOLD FOR PRODUCING MELT-SPUN FILAMENTS OR YARNS

(71) Applicant: TRÜTZSCHLER GROUP SE, Mönchengladbach (DE)

(72) Inventors: Michael Lüttinger, Winterthur (CH); Stefan Bozzini, Schaffhausen (CH); Maximilian Krause, Lottstetten (DE); Michael Rapold, Marthalen (CH); Sabine Hafner, Neuhausen (CH)

(21) Appl. No.: 19/126,563

(22) PCT Filed: Sep. 19, 2023
(86) PCT No.: PCT/EP2023/075712

§ 371 Date: May 1, 2025

(30) Foreign Application Priority Data
Nov. 2, 2022 (EP) EP22205124

(51) Int. Cl. D01D 4/06; D01D 5/08; D01D 11/00

(52) U.S. Cl. CPC D01D 4/06; D01D 5/08; D01D 11/00

(57) ABSTRACT

A spin-die manifold includes a nozzle throat having long sides and short sides, in which a spinning pack is arranged with a spinneret arranged underneath, and at least one distribution block having a spinning pump. Liquid plastic is conveyed to the spinning pump via an extruder, which conveys the liquid plastic to the spinning pack via the at least one distribution block via distribution lines arranged inside the distribution block. At least one distribution block is arranged on a long side of the nozzle throat. The nozzle throat has at least one surface heating element on each of its vertical flat long and short sides. The at least one distribution block has at least one surface heating element on at least one part of its upper or lower outer surface. The surface heating elements electrically heat at least this part of the long and short sides and outer surface.

The invention relates to a spin-die manifold for producing melt-spun filaments or yarns according to the preamble of claim 1.

The known spin-die manifolds have spinning packs that are arranged in rows on the underside of the spin-die manifold. Depending on the size of the system, several spin-die manifold modules are arranged next to each other and are firmly connected to each other via pipes for the heat transfer medium. Usually, oil or dyphyl is used as the heating medium and is present in the heating circuit in liquid or gaseous phase. The technical complexity of the system for these heating media is very high and requires space, as a vacuum station, heating system, high-temperature boiler and pressure vessel are required, which must be replaced or modularly expanded if the spin-die manifold is enlarged. Moreover, handling these media is critical for safety reasons and is not environmentally friendly in the event of defects.

An example of a modular spin-die manifold is described in EP 3242966 A1. A further disadvantage is a mostly uniform temperature level, which is advantageous for the liquid plastic, but consumes unnecessary energy for individual components of the spin-die manifold, as variable adjustment of the temperature level to individual components is only possible with increased effort. To regenerate individual components after the plastic has frozen, additional electrical heating systems are known that use a hot air blower, among other things, which is disadvantageous in terms of system technology and energy consumption.

DE 21 2004 000 010 U1 discloses the arrangement of electrical heating conductors on the upper and lower sides and the use of locally arranged heating cartridges. The outer sides of the intermediate plate provided with melt lines are not heated.

Accordingly, the problem addressed by the invention is that of developing a cost-effective spin-die manifold in such a way that it is very compact, modularly expandable and the temperature level of individual components can be variably adjusted.

The invention solves the problem posed by a spin-die manifold having the features specified in claim 1. Advantageous developments of the invention are defined in the dependent claims.

The invention relates to a spin-die manifold for producing melt-spun filaments or yarn, comprising at least one nozzle throat with two vertical flat long sides and at least two vertical flat short sides, in which at least one spinning pack is arranged with a spinneret arranged underneath. The spin-die manifold has at least one distribution block with at least one spinning pump, wherein liquid plastic is conveyed via an externally arranged extruder to the at least one spinning pump, which conveys the liquid plastic to the at least one spinning pack via the at least one distribution block by means of distribution lines, which are arranged inside the distribution block.

The invention includes the technical teaching that the at least one distribution block is arranged on a long side of the nozzle throat and that the nozzle throat has at least one surface heating element on each of its vertical flat long and short sides, and the at least one distribution block has at least one surface heating element on at least one part of its upper or lower outer surface, wherein the surface heating elements are designed to electrically heat at least this part of the long and short sides and outer surface.

Heating by means of electric heating cartridges and encapsulating the nozzle throat and distribution block using electric surface heating elements, as well as encasing the melt line using the electric heating sleeve, eliminates the need for the entire previous heating medium and considerably simplifies design and production. Boilers, double-walled pipes and complex welding and testing procedures can be dispensed with. In addition, entire assemblies of the previous heating system and the vacuum station can be dispensed with. The design is more compact than the previous solution and is more suitable for modular expansion. Transportation and installation are simplified. Despite the higher heating costs due to the electrical energy compared to fossil fuels, there are clear advantages, as the operation of the system also becomes safer and investment costs are reduced. In addition, the temperature level can be controlled more specifically by actuating individual surface heating elements. Furthermore, the overall temperature level can be easily adapted to the plastic used and/or the product to be manufactured via the power fed in.

A long-side end wall of the distribution block is arranged on a long side of the nozzle throats, wherein both the distribution block and the nozzle throats are connected via common lines for feeding the molten plastic into the spinning packs. This constructive arrangement of the distribution block on the nozzle throats shortens the supply lines for the liquid plastic.

In this case, at least the vertical outer surfaces of the nozzle throat are clad with surface heating elements, as these radiate the most heat and the plastic melt is fed vertically into the spinnerets through the spinning packs. The upper side of the nozzle throat with the spinning packs can be conventionally insulated from the surrounding environment.

The surface heating elements can consist of a combination of steel and brass or ceramic and can be designed to heat the outer surfaces of the nozzle throat and the distribution block. In contrast to the prior art, heating coils are not laid in grooves, but flat elements are arranged from the outside and detachably fastened, which generate a uniform temperature increase over the entire surface.

The surface heating elements can be suspended and clamped to the outer surfaces using fastening elements, so that they can be quickly removed for maintenance of the spin-die manifold.

Because the distribution block is clad with surface heating elements at least on the top and bottom, it can serve as a heat accumulator so that the supply lines from the distribution block to the spinning packs do not freeze over.

In an advantageous development of the invention, electrical heating can also be provided by means of heating cartridges. The heating cartridges can be arranged variably in the spin-die manifold and can be controlled individually. In this way, the temperature level of individual surface heating elements and thus also the individual components of the spin-die manifold can be controlled separately with regard to the temperature level and speed of the achievable temperature level.

Preferably, the nozzle throat has partition walls between every two spinning packs, which are designed to accommodate heating cartridges. The spinning packs can thus be heated evenly on all vertical surfaces.

The fact that the surface heating elements can be detached from the nozzle throat and/or the distribution block means that the spin-die manifold can be accessed very quickly for maintenance work. This avoids handling the energy/heat transfer media (oil, dyphyl) in a manner that is hazardous to safety according to the prior art.

The distribution block can be formed of several parts so that the feed and distribution lines can be incorporated into individual elements of the distribution block. This can be done, for example, by machining or eroding manufacturing processes. Open feed and/or distribution lines can be arranged in at least one part of the distribution block, which are closed by a second part of the distribution block. The distribution block is preferably of a flat design and is connected to the nozzle throat with a long end edge. This means that the feed and distribution lines are aligned horizontally. It simplifies the installation of suitable surface heating elements.

The flat upper side of the distribution block is used to arrange a spinning pump on or partially in the distribution block. This shortens the lines that transport the liquid plastic.

An additional shortening of the lines is achieved by the fact that the distribution block is designed to guide the liquid plastic from the external extruder to the spinning pump.

The components of the distribution block are fastened together and clamped in a sealing manner using fastening elements so that the supply and distribution lines are sealed off from the surrounding environment. The integration of the supply and distribution lines into the distribution block reduces the installation work involved in laying individual pipes, which according to the prior art must all be individually insulated and heated. The use of surface heating elements simplifies the construction of the distribution block.

The combination of the spinning pump with the distribution block enables several variants of feeding the liquid plastic, according to which the liquid plastic is fed to each spinning pack in the distribution block without branching or with several branches. This allows the heating power to be reduced and adjusted based on the branches.

The spin-die manifold can have a control system that is designed to control the heating phase of the surface heating elements and the heating cartridges individually and to monitor the temperature level of each surface heating element and each heating cartridge individually. If a surface heating element or heating cartridge exceeds the preset temperature, the heating function can be stopped until all surface heating elements and heating cartridges are within the same tolerance range. The same temperature level is thus achieved for all spinning packs so that the filaments to be produced can have identical technical properties.

Temperature sensors can be used to determine the temperature of the surfaces to be heated and the data from the temperature sensors can be transmitted to the control system. Preferably, the surface heating elements can be combined to form a heating zone or groups of heating zones.

The control system of the spin-die manifold can have a warning function that is activated if the temperature exceeds or falls below a temperature tolerance and/or preset temperature differences of the surfaces to be heated.

Further measures that improve the invention are described in greater detail below together with the description of a preferred exemplary embodiment of the invention with reference to the figures, in which:

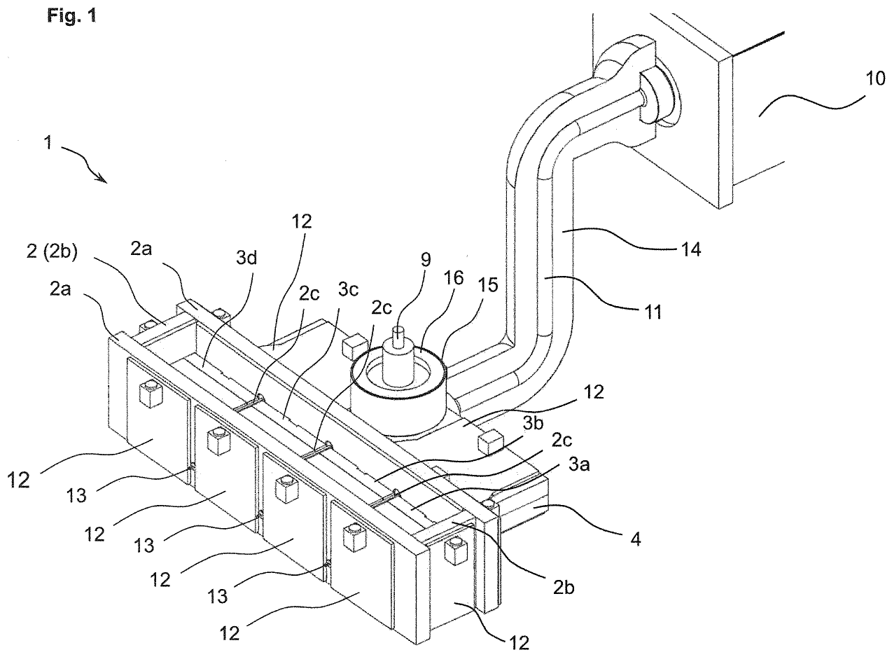

FIG. 1: shows a detailed representation of a spin-die manifold;

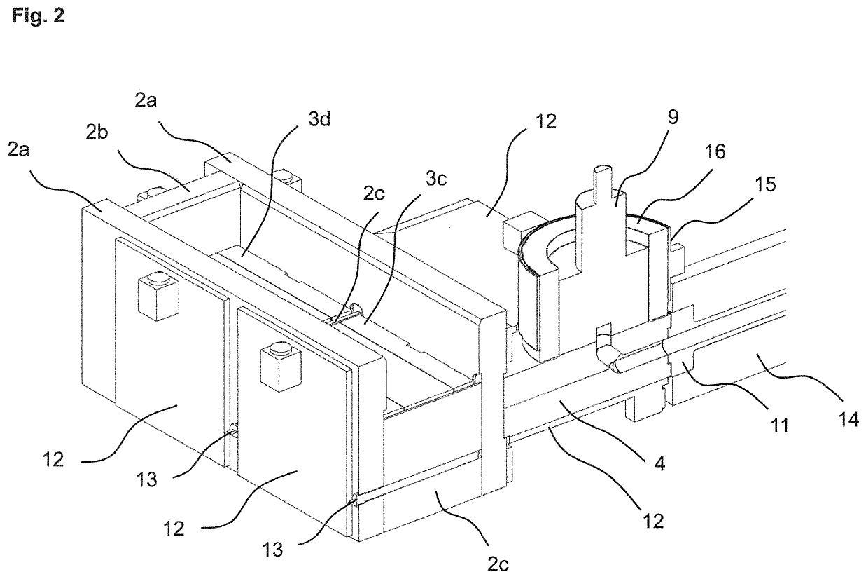

FIG. 2: shows a sectional view of a nozzle throat with distribution block;

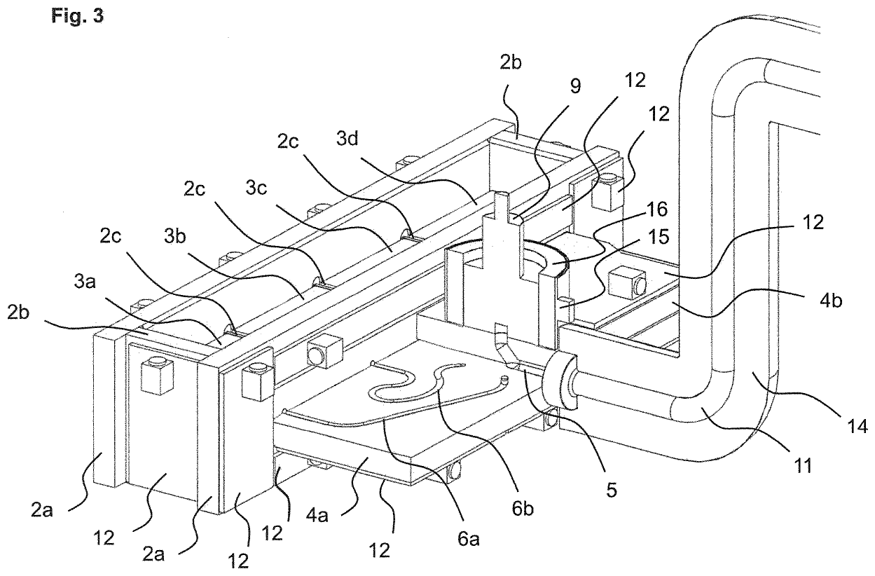

FIG. 3: shows a partial section through the upper part of the distribution block;

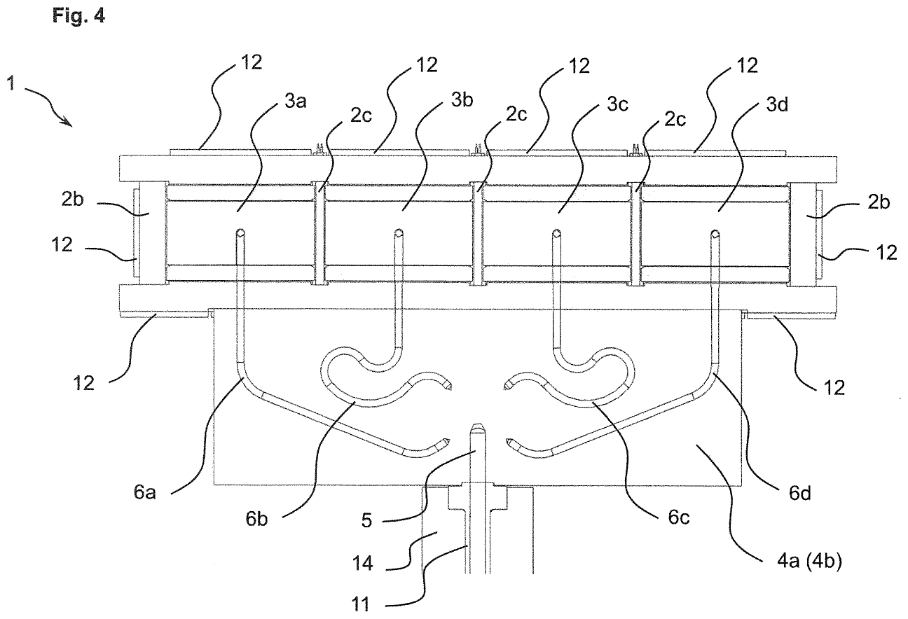

FIG. 4: shows a sectional view of the spin-die manifold with the half-cut upper part of the distribution block;

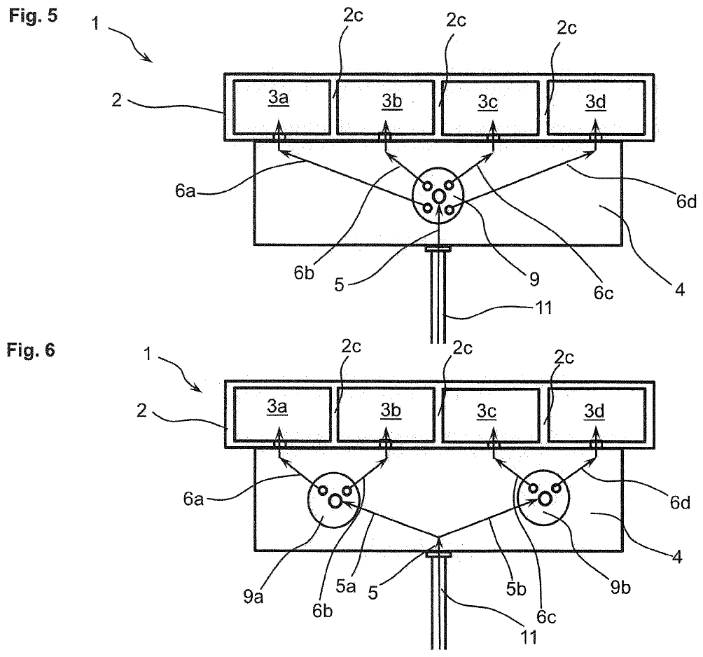

FIG. 5: shows a schematic representation of the pipe system in a distribution block;

FIG. 6: shows another schematic representation of the pipe system in a distribution block;

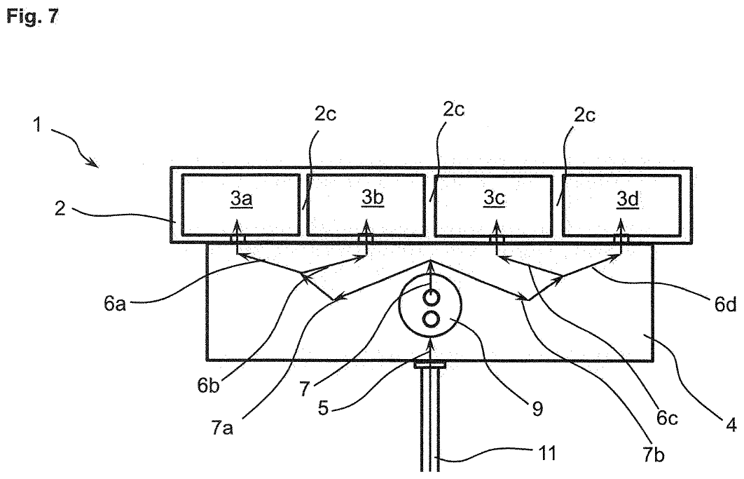

FIG. 7: shows another schematic representation of the pipe system in a distribution block.

FIG. 1 shows a detailed illustration of a spin-die manifold 1 with an externally arranged extruder 10, which liquefies solid plastics parts and feeds the liquefied plastic to a distribution block 4 via a melt line 11. A spinning pump 9 is arranged on the distribution block 4 and pumps the liquid plastic into four spinning packs 3a-3d via integrated lines in the distribution block 4. The spinning pump 9 is surrounded by a heat storage tube 16 with encased cylindrical heating elements 15. The spinning packs 3a-3d are arranged in a heated nozzle throat 2, the outer contour of which is formed by at least two long sides 2a and two short sides 2b in this exemplary embodiment. The spinning packs 3a-3d can be arranged separately from one another by means of central webs 2c within the nozzle throat 2. Below the spinning packs 3a-3d or integrated in the spinning packs 3a-3d there are spinnerets, not shown, from which the liquid plastic is drawn off in the form of thin filaments. The distribution block 4 and the nozzle throat 2 have surface heating elements 12 on the outside, which are designed to keep the liquid plastic in a molten state. The melt line 11 is additionally heated by at least one heating sleeve 14 so that the liquid plastic does not freeze on its way between extruder 10 and distribution block 4. Each spin-die manifold 1 comprises at least one nozzle throat 2, in which at least one spinning pack 3a is arranged, and a distribution block 4 with at least one spinning pump 9. In comparison to the nozzle throat 2, which is designed as an elongate block with approximately the same height and depth, the distribution block 4 is designed here as a flat element comprising a lower and at least one upper plate 4a, 4b. The distribution block 4 is made up of several parts, wherein the feed lines 5, 5a, 5b and/or distribution lines 6a-6d are incorporated into a flat element 4a so that they are open on one side. This can be achieved, for example, by means of machining or eroding manufacturing processes. The at least second flat element 4b of the distribution block is designed to close the open lines. The feed lines 5, 5a, 5b and/or distribution lines 6a-6d can be incorporated in both flat elements corresponding to each other or only in one flat element (top or bottom) of the distribution block 4. The advantage lies in the simple manufacturing process, which means that individual lines do not have to be laid, heated and insulated. A further advantage is the integration of the spinning pump 9 on or in the distribution block 4, whereby the waste heat from the distribution block 4 can be used for the spinning pump 9 and the lines to be heated are kept short.

A long-side end wall of the distribution block 4 is arranged on the nozzle throat 2, wherein both the distribution block 4 and the nozzle throat 2 are connected via common lines for feeding the plastic melt into the spinning packs 3a-3d. In this exemplary embodiment, all vertical flat long and short sides 2a, 2b of the nozzle throat 2 are covered with surface heating elements 12. At least the central webs 2c, which separate the individual spinning packs 3a-3d from each other, have electrically actuated heating cartridges 13, which are designed to generate the required temperature within the nozzle throat 2. The distribution block 4 has at least one surface heating element 12 on the top and bottom. The surface heating elements 12 are clamped or suspended to the surfaces to be heated by means of fastening elements, not shown. The fastening is designed so that the surface heating elements 12 can be removed very quickly.

The heating sleeve 14 consists of a glass-insulated heating conductor, which is manufactured to fit the melt line precisely. The heating sleeve can be operated with a heating power of 600 W, for example, and heat the melt line to 320° C. Depending on the shape of the feed line, one or more heating sleeve elements 14 can be used.

The surface heating elements 12 can consist of a combination of steel and brass or ceramic and are designed to heat the outer surfaces of the nozzle throat 2 and the distribution block 4 to 320° C., for example. Each surface heating element 12 can be operated with a heat output of 300 W, for example. They can have slots for hanging in a device and additional holes for fastening using screws or other fastening elements. There are also holes through which heating cartridges or thermal sensors can be inserted into the individual components of the spin-die manifold.

The heating cartridges 13 can be made of high-temperature resistant steel alloy or ceramic and can be inserted into the nozzle holder 2 and the distribution block 4, for example by screwing them in, and are designed to heat the components up to 320° C. Each heating cartridge 13 can be operated with a heating power of 100 W, for example. The heating cartridges 13 can be combined with thermocouples to monitor the current temperature.

According to FIG. 2, several central webs 2c are arranged between the spinning packs 3a, 3b; 3b, 3c; 3c, 3d (only the spinning packs 3c and 3d are shown here) in the nozzle throat 2, which can also have several heating cartridges 13 and/or a surface heating element 12 in order to ensure a uniform temperature of the spinning packs 3a-3d on all sides.

FIG. 3 shows the distribution block 4, which substantially consists of an upper and a lower plate 4b, 4a. A surface heating element 12 has been removed from the upper plate 4b and the upper plate 4b is shown cut in half. The grooves that are milled into the separating surface of both plates 4a, 4b or only into one plate 4a or 4b as a line can be seen here. A feed line 5 runs from the melt line 11 (heating sleeve 14 shown in half section) to the spinning pump 9, which is also shown in half section in the lower area. From the spinning pump 9, which is mounted on or in the upper plate 4b of the distribution block 4, four distribution lines 6a-6d each go to the nozzle throat 2 and then into the spinning packs 3a-3d, wherein the nozzle throat 2 has associated openings from which the polymer melt is fed through the nozzle throat 2 into the spinning packs 3a-3d via the distribution lines 6a-6d. As a result, the working pressure of the extruder 10 transports the liquid plastic from the extruder 10 via the melt line 11 and the feed line 5 to the spinning pump 9. This transports the liquid plastic via the distribution lines 6a-6d to the individual spinning packs 3a-3d. This arrangement of the spinning pump 9 on or in the distribution block 4 enables a variable arrangement of the feed and distribution lines in order to forward the liquid plastic to the spinning packs 3a-3d with as few branches (splits) as possible.

FIG. 4 shows a plan view of FIG. 3 without the spinning pump 9 and without the upper plate of the distribution block 4b. The feed line 5 and the four distribution lines 6a-6d, each leading to one of the spinning packs 3a-3d shown here, can be seen here. The plan view in FIG. 4 also shows the surface heating elements 12, which surround the spin-die manifold 1 on the vertical outer surfaces. The central webs 2c from FIG. 2 can also be seen between the spinning packs 3a-3d and are arranged between the spinning packs 3a, 3b; 3b, 3c; 3c, 3d and can accommodate the heating cartridges 13. Depending on the number of spinning pumps 9, of feed lines 5 and of spinning packs 3a-3d, the number of milled distribution lines 6a-6d in the distribution block 4 also changes. There may be a variant whereby the plastic melt passes through a so-called hydraulic split before and/or after the spinning pump 9, i.e., is branched. This describes the fact that the plastic melt splits independently under the pressure of the spinning pump 9 or the extruder 10 through a milled branch or line in the distribution block 4 and thus feeds the spinning packs 3a-3d.

FIG. 5 shows a simplified arrangement of the distribution lines 6a-6d, which run from the spinning pump 9 to the spinning packs 3a-3d. The spin-die manifold 1 has four spinning packs 3a-3d, which are arranged next to each other, separated from each other by a heated central web 2c. The distribution block 4 has a single spinning pump 9, via which the polymer melt is distributed to the spinning packs 3a-3d by means of the distribution lines 6a-6d. There is no branching of the feed or distribution lines 5, 6a-6d (0 split).

In FIG. 6, the spin-die manifold 1 also has four spinning packs 6a-6d, which are arranged next to each other, each separated from the other by a heated central web 2c. The distribution block 4 has two spinning pumps 9a, 9b, via which the polymer melt is distributed. The feed line 5 is divided into two strands 5a, 5b (1 split) within the distribution block 4, wherein one strand or line 5a, 5b supplies a separate spinning pump 9a, 9b. Accordingly, two spinning pumps 9a, 9b are arranged on the distribution block 4, each of which supplies two spinning packs 3a, 3b; 3c, 3d with polymer melt. Two spinning packs 3a, 3b; 3c, 3d are each supplied with polymer melt from the spinning pumps 9a, 9b without further branching, each with a separate distribution line 6a-6d.

FIG. 7 again shows a spin-die manifold 1 with four spinning packs 3a-3d and a single spinning pump 9 on the distribution block 4, wherein a pump line 7 after the spinning pump 9 splits into two pump lines 7a, 7b and branches out by means of two further distribution lines 6a, 6b; 6c, 6d to form two spinning packs 3a, 3b; 3c, 3d each. Each distribution line 6a-6d again supplies one spinning pack 3a-3d, so that with four spinning packs 3a-3d and one spin pump 9, the polymer melt is fed to the spinning packs via a total of three branches (3× split).

The heating of the melt line 11 by means of a heating sleeve 14, the variable use of the electric heating cartridges 13 and the encapsulation of the nozzle throat 2 and the distribution block 4 by means of surface heating elements 12 eliminates the entire previous heating medium and considerably simplifies the design and manufacture. Boilers, double-walled pipes and complex welding and testing procedures can be dispensed with. In addition, entire assemblies of the previous heating system and the vacuum station can be dispensed with. The design is more compact than the previous solution and is more suitable for modular expansion. Transportation and installation are simplified. In contrast to the prior art, in which the distribution block 4 is not heated but only insulated, it now has its own surface heating elements 12, which means that the distribution block 4 now also serves as a heat accumulator. The surface heating elements 12 can be removed very quickly, making it easier to maintain the spin-die manifold. The integration of the distribution lines 6a-6d in the distribution block 4 facilitates the manufacture and assembly, and the heating of the distribution lines 6a-6d. The arrangement of the spinning pump 9 on or in the distribution block 4 enables an optimum distribution of the branches in the distribution lines 6a-6d of the distribution block 4, depending on the spinning packs to be fed. The transport paths for the liquid plastic are kept short and the waste heat from the distribution block 4 can be used for the spinning pump 9.

The spin-die manifold has a control system which is designed to control the heating phase of the heating sleeve 14, the surface heating elements 12 and the heating cartridges 13 individually and to monitor the temperature level of each heating sleeve 14, each surface heating element 12 and each heating cartridge 13 individually. If a heating sleeve 14, a surface heating element 12 or a heating cartridge 13 exceeds the preset temperature, the heating function can be stopped until all heating sleeves 14, surface heating elements 12 and heating cartridges 13 are within the same tolerance range.

The temperature of the surfaces to be heated is measured directly in the associated component, for example in a hole, near the surface heating element 12 by a temperature sensor. This temperature sensor can also be used to control the heating elements.

Additional temperature sensors monitor the spin-die manifold 1 and enable the extruder 10 or the spinning pump 9, for example, to be switched off.

The heating sleeve 14, surface heating elements 12 or heating cartridges 13 can be combined to form a heating zone or groups of heating zones. The additional temperature sensors, which are not used for control, can perform a monitoring and control function.

The spin-die manifold control system has a warning function if the temperature tolerance is exceeded or not reached and/or if large differences are detected in the activation of the heating zones. The alarm function is activated if the tolerance exceeds the tolerance time set by the customer, or if a sensor is defective, or if the temperature exceeds the maximum set value, or if the temperature exceeds the maximum operating temperature, or if a heating zone does not reach the set temperature in the desired time or rises too quickly within a defined time.

### REFERENCE SIGNS

1 spin-die manifold
2 nozzle throat
2a long side
2b short side
2c central web
3a-d spinning pack
4 distribution block
4a lower plate
4b upper plate
5, 5a, 5b feed line
6a-d distribution line
7, 7a, 7b pump line
9, 9a, 9b spinning pump
10 extruder
11 melt line
12 surface heating element
13 heating cartridge
14 heating sleeve
15 cylindrical heating element
16 heat storage tube

1. A spin-die manifold for producing melt-spun filaments or yarn, comprising at least one nozzle throat, with two vertical flat long sides and at least two vertical flat short sides, in which at least one spinning pack is arranged with a spinneret arranged underneath, and at least one distribution block with at least one spinning pump, wherein liquid plastic is conveyed via an externally arranged extruder to the at least one spinning pump, which conveys the liquid plastic via the at least one distribution block by means of distribution lines, which are arranged inside the distribution block, to the at least one spinning pack, wherein the at least one distribution block is arranged on a vertical flat long side of the nozzle throat, and wherein the nozzle throat has at least one surface heating element on each of its vertical flat long and short sides, and the at least one distribution block has at least one surface heating element on at least one part of its upper or lower outer surface, wherein the surface heating elements are designed to electrically heat at least this part of the long and short sides and outer surface.

2. The spin-die manifold as claimed in claim 1, wherein the surface heating elements consist of a steel-brass combination or of ceramic and are designed to heat the outer surfaces of the nozzle throat and of the distribution block.

3. The spin-die manifold as claimed in claim 1, wherein the electrical heating is additionally provided by means of heating cartridges.

4. The spin-die manifold as claimed in claim 1, wherein the nozzle throat has central webs between each two spinning packs, which central webs are designed to receive heating cartridges.

5. The spin-die manifold as claimed in claim 1, wherein the surface heating elements are removably attached to the nozzle throat and/or to the distribution block.

6. The spin-die manifold as claimed in claim 1, wherein the distribution block is formed of several parts, wherein open feed and/or distribution lines are arranged at least in one part of the distribution block and are closed by a second part of the distribution block.

7. The spin-die manifold as claimed in claim 1, wherein the at least one spinning pump is arranged on or partially in the distribution block.

8. The spin-die manifold as claimed in claim 7, wherein the distribution block is designed to guide the liquid plastic from the external extruder to the spinning pump.

9. The spin-die manifold as claimed in claim 1, wherein the liquid plastic in the distribution block is passed to each spinning pack without branching or with branching.

10. The spin-die manifold as claimed in claim 6, wherein the multi-part distribution block is fastened together with at least two or more fastening elements and clamped in a sealing manner.

11. The spin-die manifold as claimed in claim 1, wherein a control system controls the heating phase of the surface heating elements and the heating cartridges individually and monitors the temperature level of each surface heating element and each heating cartridge individually.

12. The spin-die manifold as claimed in claim 11, wherein by means of temperature sensors, the temperature of the surfaces to be heated is determined and the data from the temperature sensors are transmitted to the control system.

13. The spin-die manifold as claimed in claim 11, wherein the surface heating elements can be joined together to form a heating zone or groups of heating zones.

14. The spin-die manifold as claimed in claim 11, wherein the control system of the spin-die manifold has a warning function which is activated when the temperature exceeds or falls below a temperature tolerance and/or preset temperature differences of the surfaces to be heated.
